(19) United States
(12) Patent Application Publication
(10) Pub. No.: US 2015/0308411 A1
(43) Pub. Date: Oct. 29, 2015

(54) AIRBORNE WIND ENERGY SYSTEM WITH REDUCED INPUT TORQUE, BETTER TORQUE HANDLING AND OPTIMIZED SPEED

(71) Applicant: Leonid Goldstein, Austin, TX (US)

(72) Inventor: Leonid Goldstein, Austin, TX (US)

(21) Appl. No.: 14/791,505

(22) Filed: Jul. 6, 2015

Related U.S. Application Data
(63) Continuation of application No. PCT/US13/77886, filed on Dec. 26, 2013.
(60) Provisional application No. 61/750,921, filed on Jan. 10, 2013.
(60) Provisional application No. 61/754,925, filed on Jan. 21, 2013.
(60) Provisional application No. 61/757,181, filed on Jan. 27, 2013.
(60) Provisional application No. 61/762,912, filed on Feb. 10, 2013.
(60) Provisional application No. 61/892,412, filed on Oct. 17, 2013.

(51) Int. Cl. F03D 9/00; F03D 5/00; F03D 7/00; B64C 31/06

(52) U.S. Cl. CPC F03D 9/002; B64C 31/06; F03D 5/00; F03D 7/00

(57) ABSTRACT

An airborne wind energy conversion system with lower input torque and/or better handling of the input torque. In one embodiment it has a ground generator, and a tether pulls an elongated member which is meshed with a gear of relatively small diameter. The system achieves relatively high initial RPM and relatively low initial torque. In another embodiment a wide and thin belt unwinds from a spool, having annulus-planet relation with the gear (like in a planetary gearbox). The gear is rotationally coupled to the rotor of the generator. In another aspect, the ratio of the wing air speed to the wind speed is normally below ⅔, which was taught as the optimum since Loyd.

### CROSS REFERENCE TO RELATED APPLICATIONS

This application is a continuation of PCT Application No. PCT/US13/77886, filed 26 Dec. 2013, which claims the benefit of U.S. Provisional Applications No. 61/750,921, filed 10 Jan. 2013, No. 61/754,925, filed 21 Jan. 2013, No. 61/757,181, filed 27 Jan. 2013, No. 61/762,912, filed 10 Feb. 2013 and No. 61/892,412, filed 17 Oct. 2013 by the same inventor as herein, the entire disclosure of which is incorporated herein by reference.

### BACKGROUND OF THE INVENTION

The airborne wind energy conversion holds a number of promises. The winds at the altitude have higher energy and are more reliable than winds near the ground. An airborne wing is potentially less expensive and more mechanically efficient than the blades of the conventional wind turbines. AWEC systems do not require towers. High altitude AWEC systems might have no adverse environmental impacts, exhibited by the conventional wind turbines. There were suggested a number of wind energy conversion devices, in which a tethered airborne wing or a parachute harvests wind energy, pulls the tether, and the tether unwinds from a drum on the ground, rotating that drum. The drum is rotationally connected to a rotor of an electrical generator via a gearbox. Some examples are U.S. Pat. No. 8,080,889 by Ippolito et al (cross wind kite with two tethers), U.S. Pat. No. 6,523,781 by Ragner (simple kite), PCT/EP2009/060311 by Zanetti et al (drag based, parachute like sails), U.S. Pat. No. 8,109,711 by Blumer. Modern AWECS with cross wind kite motion were pioneered by Miles L. Loyd in his article “Crosswind Kite Power” (Energy Journal, 1980; 4:106-11), who learnt some ideas from U.S. Pat. No. 3,987,987 by Payne and McCutchen. The article “KiteGen project: control as key technology for a quantum leap in wind energy generators” by M. Canale et al (Proc. of American Control Conference, New York 2007) and U.S. Pat. Nos. 7,504,741 & 7,546,813 by Wrage et al provide additional teaching on the subject. Nevertheless, the experiments with such devices have not been successful so far. One of the challenges that they face is the low speed of the tether roll out, which must be less than the speed of the wind. Low speed requires high force, according to the equation Power=Force×Speed. Low speed of the tether roll out causes low angular speed of the drum, with the accompanying high torque. This necessitates a gearbox, designed for high input torque and providing a large ratio of speed increase. The problem is getting worse with increase in the system power, because the tether tension grows proportionally to the power, and the thickness of the tether grows proportionally to the square root of the tension. Higher thickness of the tether requires larger diameter of the drum, further decreasing angular speed. Another problem is asymmetrical and non-torsional application of the tether's force to the drum. Ockels and Lansdorp have proposed an original concept of Laddermill and discussed using a tape instead of conventional tether in their paper “Design of a 100 MW laddermill for wind energy generation from 5 km altitude” (7th World Congress on Recovery, Recycling and Re-integration, Beijing, 2005). Unfortunately, the Laddermill was unsuccessful, and the wide tape cannot be used instead of the tether in AWECS with cross wind motion because of the high drag and flutter.

Thus, there remains a considerable need for the airborne wind energy conversion system solving the problems mentioned above and providing economically viable wind energy conversion.

### SUMMARY OF THE INVENTION

The invention is directed to a device and a method for converting energy of wind into electrical energy.

One aspect of the invention is recognition of the problems that are created by force transfer by a tether, unwinding from a drum. Some of these problems are: a) the tether with round cross section requires a large spool diameter and special arrangements to lay it along the length of the spool, when winding back; b) large bending forces, acting on the drum axle, caused by asymmetrical application of the tether pull along both the diameter of the spool and the length of the axle. It is suggested to solve these problems i) by separating a spool and a gear; and/or ii) by using a flat belt, possibly very wide and thin, by integrating a gearbox (or at least its input gear) with the spool; and/or iii) by using higher reel out speeds, than is customary now.

One embodiment of the invention is a device for converting wind energy into electrical energy, comprising an airborne member; a tether, coupled to the airborne member; an elongated member, coupled to the tether; a rotational member, contacting the elongated member; an electrical generator comprising a rotor and a stator; wherein the rotor of the electrical generator is rotationally coupled to the rotational member.

The electrical generator is placed on or near the ground or the water surface. Examples of the suitable airborne member are an airfoil and a parachute. The elongated member can be flexible or non-flexible. The flexible member can be flat. Examples of a flexible elongated member are a perforated belt and a chain. An example of a non-flexible elongated member is a rack. Examples of the rotational member are a sprocket, a gear and a pinion. The elongated member is significantly (10 times or more) longer than the diameter of the rotational member. The tether can be a rope, a wire or a cable. An additional control system can be provided to control the wings and the parameters of the system operation.

In some preferable variations, the elongated member is relatively straight around its points of contact with the rotational member. The term “relatively straight”, as used here, means either substantially straight or having radius of curvature, noticeably (2 times or more) larger than the radius of the rotational member, or changing direction by only a small angle (60 degrees or less) in the point of contact with the rotational member.

In some preferable variations, the elongated member has teeth or holes along its length; the rotational member has teeth along its circumference; and the rotational member meshes with the elongated member.

Another embodiment of the invention is a method for converting wind energy into electrical energy, comprising steps of: capturing wind energy with a tethered airborne member; converting motion of the airborne member into periodical linear motion of an elongated member at the ground; converting the periodical linear motion of the elongated member into rotational motion of the rotational member using frictionless contact; converting rotational motion of the rotor into electrical energy.

Another embodiment of the invention is a device for converting wind energy into electrical energy, comprising: an airborne sub-assembly, comprising an airborne member; and a tether, coupled to the airborne member; a ground subassembly, comprising a belt, coupled to the tether and at least partially wound on a spool; a gear, integrally combined with the spool; a pinion, meshed with the gear; an electrical generator comprising a rotor and a stator; wherein the rotor of the electrical generator is rotationally coupled to the pinion. The gear can be an internal toothed gear inside of the spool or an external toothed gear outside of the spool. The pinion can also serve as the main support for the spool against the pull of the tether. The ground subassembly is placed on or near the ground or the water surface. Examples of the suitable airborne member are an airfoil and a parachute. The tether can be a rope, a wire or a cable. An additional control system can be provided to control the wings and the parameters of the system operation. The belt can be a flat belt, a non-adhesive tape or be a strip of fabric or another material, having sufficient strength and sufficiently thin. The fabric may be made of carbon fiber or UHWMA or another strong fiber. The fabric may have uneven strength in different directions, with preferably the largest strength in the direction of the length. In some variations, multiple pinions can mesh with the gear.

Another embodiment of the invention is a device for converting wind energy into electrical energy, comprising: an airborne sub-assembly, comprising an airborne member; and a tether, coupled to the airborne member; a ground subassembly, comprising a belt with the ratio of the sectional width to the sectional height 10:1 or more, coupled to the tether and at least partially wound on a spool; an electrical generator comprising a rotor and a stator; wherein the rotor of the electrical generator is rotationally coupled to the spool.

Another embodiment of the invention is a device for converting wind energy into electrical energy, comprising: an airborne member, adapted to harvest wind energy; a tether, the first end of which is coupled to the airborne member; an electrical generator on the ground comprising a rotor and a stator; a rotatable spool, rotationally coupled to the rotor of the electrical generator; the second end of the tether is attached to a plurality of ropes or belts of smaller section than the section of the tether, winding on/off the spool.

In the systems described above, the airborne member is an airfoil, flying mostly crosswind.

Another aspect of the invention is a device for converting wind energy into electrical energy, comprising: an airfoil, adapted to harvest wind energy by moving cross wind; a tether, coupled to the airfoil and to an object on the ground or in the water; an electronic control system for controlling the airfoil; wherein the strength of the tether and of the airfoil is optimized for operation with the nominal residual speed coefficient below ⅔.

Another aspect of the invention is a device for converting wind energy into electrical energy, comprising: an airfoil, adapted to harvest wind energy by moving cross wind; a tether, coupled to the airfoil; a rotational member, coupled to the tether; an electrical generator comprising a rotor, wherein the rotor is rotationally coupled to the rotational member; wherein the strength of the tether and of the airborne member and of the rotational member is designed for energy conversion when the tether reel out speed is higher than ⅓ of the normal wind speed in the nominal wind.

Various objects, features, aspects, and advantages of the present invention will become more apparent from the following detailed description of preferred embodiments of the invention, along with the accompanying drawings in which like numerals represent like components.

The description uses earlier published patent applications by the inventor:

### PCT/US12/66331 (01-PCT)

### PCT/US12/67143 (02-PCT)

### PCT/US13/30314 (06-PCT)

All referenced patents, patent applications and other publications are incorporated herein by reference, except that in case of any conflicting term definitions or meanings the meaning or the definition of the term from this disclosure applies.

### BRIEF DESCRIPTION OF THE DRAWINGS

The accompanying drawings illustrate the invention. The illustrations omit details not necessary for understanding of the invention, or obvious to one skilled in the art, and show parts out of proportion for clarity. In such drawings:

FIG. 1 shows a perspective view of an embodiment of the invention with a perforated belt being straight approach near a sprocket.

FIG. 2 shows a side sectional view of meshing of a sprocket and a perforated belt.

FIG. 3 shows the scheme of the wing motion.

FIG. 4 shows a perforated belt with multiple rows of holes.

FIG. 5 shows a side sectional view of some details of another embodiment, achieving symmetrical application of forces to the sprocket.

FIG. 6A shows a side sectional view of some details of a refinement of the previous embodiment with two sprockets and reduction gears.

FIG. 6B shows a top view of some details of the refinement with the perforated belt removed.

FIG. 7 shows a side sectional view of some details of a reverse rack and pinion embodiment.

FIG. 8 shows a perspective view of an embodiment of the invention with a power transferring spool.

FIG. 9 shows a cross section of that embodiment with schematic depiction of the gears meshing.

FIG. 10 shows a cross section of a variation with multiple pinions.

FIG. 11A shows a cross section of an embodiment with an external gear.

FIG. 11B shows a top view of the same embodiment.

FIG. 12 shows on-platform mechanisms in an embodiment with multiple ropes.

FIG. 13 shows selected details of a control system in the aspect of the invention, teaching better wind and/or tether speeds than common.

### DETAILED DESCRIPTION OF THE PREFERRED EMBODIMENTS

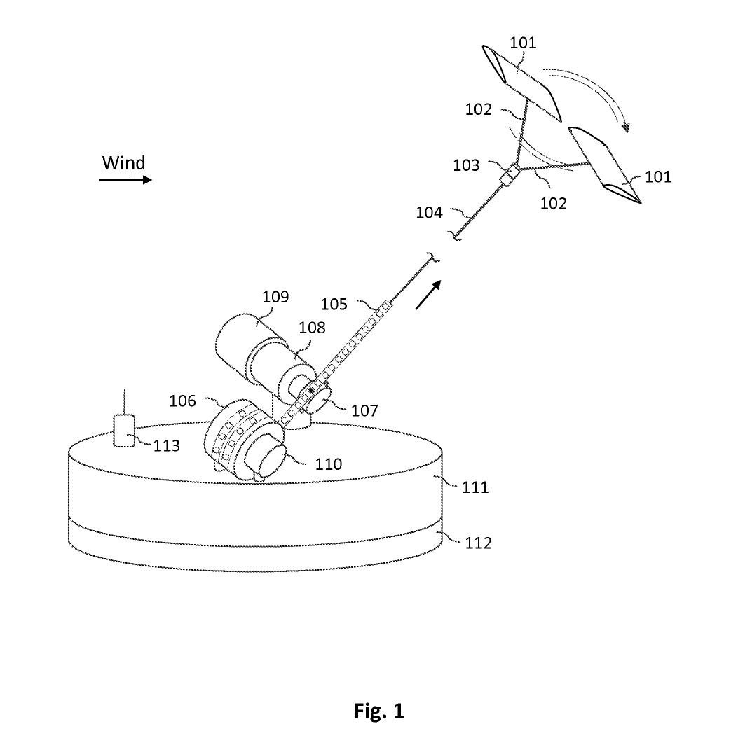

FIG. 1 shows one embodiment of the invention. It comprises a pair of wings 101, moving in the air under power of wind in a helix trajectory. Each wing 101 is attached to an anti-twist device 103 by a cable 102. The top end of a tether 104 is attached to anti twist device 103. These elements will be referred below as the airborne subassembly. A perforated belt 105 is attached to the bottom end of tether 104. Perforated belt 105 winds on/unwinds from a spool 106. In at least the working phase, the straight part of perforated belt 105 engages sprocket 107. Sprocket 107 is rotationally connected to the rotor of electrical generator 109 via a gearbox 108. An electrical motor 110 is attached to spool 106. These elements are placed on a platform 111, which can rotate on ball bearings on a foundation 112 and follow changes in the direction of the wind. Platform 111 can be enclosed. The ground based hardware of a control system 113 is placed on platform 111.

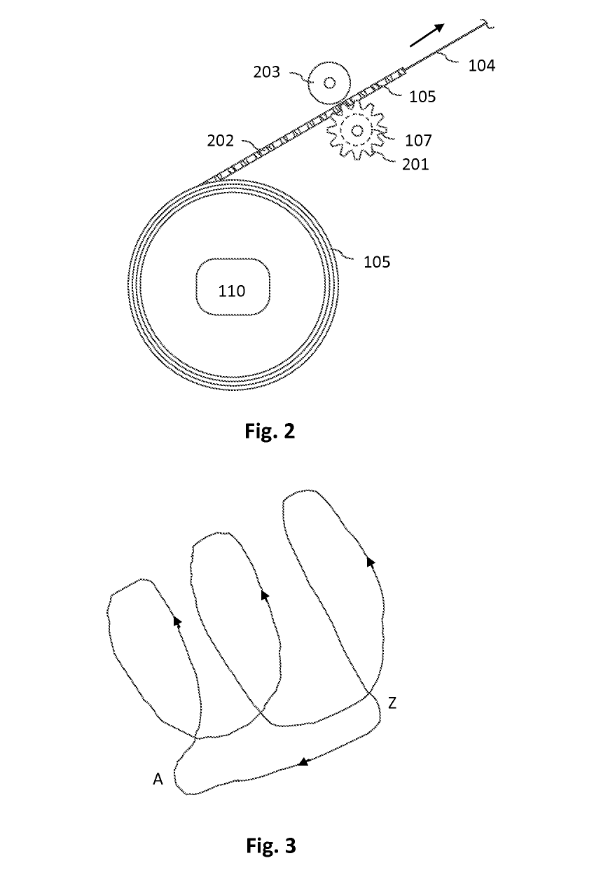

FIG. 2 shows in details, how teeth 201 of sprocket 107 engage holes 202 of perforated belt 105. A roller 203 can be optionally used to secure meshing between sprocket 107 and perforated belt 105.

Operation of the system consists of two phases—the working phase and the returning phase. The working phase starts when almost all of perforated belt 105 is wound on spool 106. In the working phase, wings 101 move in a double helix away from platform 111. Platform 111 is on the axis of the double helix, approximately. Wings 101 pull tether 104, tether 104 pulls perforated belt 105, perforated belt 105 rotates sprocket 107, which ultimately rotates the rotor of electrical generator 109. Direction of the motion of tether 104 in the working phase is shown by arrows in FIG. 1 and FIG. 2. The working phase ends when almost all perforated belt 105 is unwound off spool 106. The returning phase starts. In the returning phase, perforated belt 105 is lifted off (or otherwise disengages) sprocket 107. Electrical motor 110 rotates spool 106 in the opposite direction, winding perforated belt 105 back on spool 106. These operations are performed under command of control system 113. Perforated belt 105 pulls tether 104, which pulls wings 101 closer to platform 111, toward their original position. Control system 113 also orders wings 101 to fly a stable trajectory with minimum drag. It should be noted, that a single wing can be used instead of two wings. The advantage of the system with two wings is that tether 104 does not have significant sideway motion and thus does not waste energy on drag.

Example of trajectory of wing 101 is shown in FIG. 3. In the working phase, wing 101 flies in a helix from point A to point Z. In the returning phase, wing 101 flies more or less straight from point Z to point A. Near the point A, momentum of wing 101 is used to make wing 101 to enter circular motion, in which wing 101 can harvest wind energy. When each wing 101 is back in its point A, almost all perforated belt 105 is wound on spool 106. Control system 113 uses electrical motor 110 to stop spool 106 and to start its rotation in the opposite direction, wings 101 accelerate and start moving in a stable spiral. Control system 113 engages perforated belt 105 with sprocket 107. The returning phase ends, and the working phase starts again. It should be noted, that the returning phase can be much shorter than the working phase, and only small fraction of the energy, harvested in the working phase, is used in the returning phase. Thus, the system outputs net energy. An inexpensive flywheel can be used to supply mechanical energy to electrical generator 109 in the returning phase, ensuring continuous energy output. Instead of lifting belt 105 off sprocket 107, the system can disengage sprocket 107 from gearbox 108 in the returning phase.

It should be noted, that perforated belt 105 does not wrap around sprocket 107 even for a fraction of a round in this embodiment. Perforated belt 105 remains substantially straight, except when it wraps around spool 106, which has sufficiently large diameter as required by the thickness of perforated belt 105. One advantage of this embodiment is that it allows the sprocket to have much smaller diameter compared with the spool diameter. This translates into higher initial RPM, and allows designing gearbox 108 for lower input torque and lower speed increase. Use of the pair of wings 101, compared with a single wing, prevents sideways motion of tether 104 and drag losses, associated with it. All this allows the system to be less expensive. Example device:

Peak power: 10 MW
Tether speed: 5 m/s
Tether tension: 2 MN
Tether length: 500-3,000 m
Belt sectional area: 10 sq. cm
Belt length: 100 m

### Spool Diameter: 1 m

Sprocket diameter: 20 cm

### Sprocket RPM: 480 RPM

Cycle period: 22 seconds

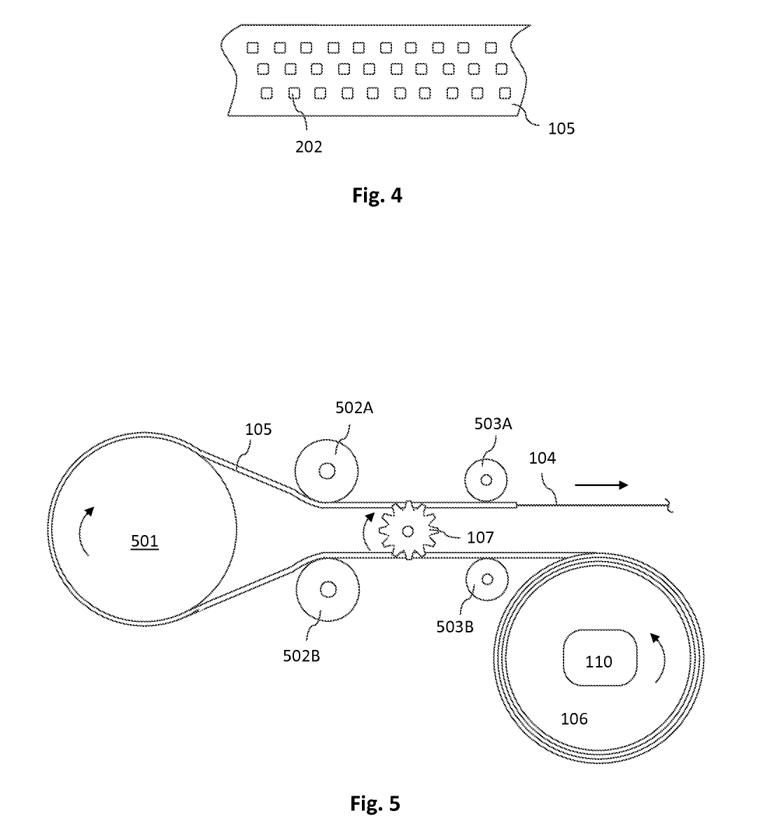

Perforated belt 105 can have a single row or multiple rows of perforation. FIG. 4 shows perforated belt 105 with multiple rows of perforations 202, offset between them. Multiple rows of perforation, engaging corresponding number of the similarly offset teeth rows on the sprocket allows achieving smoother system operation. Holes (perforations) can be inset with steel for strength and durability. A chain can be used instead of perforated belt 105. Multiple generators can be used with a single perforated belt 105.

The ground subassembly of the system in FIG. 1 and FIG. 2 has advantage of simplicity, but it has disadvantage of asymmetrical force, acting on sprocket 107. The embodiment in FIG. 5 solves this issue. This embodiment additionally comprises a sheave 501 of large diameter (close to diameter of drum 106). Perforated belt 105 wraps around sheave 501 as shown. Tightening rollers 502A and 502B are used, so that straight and parallel segments of perforated belt 105 engage sprocket 107 from the opposite sides. Additional guiding rollers 503A and 503B can be used to guide perforated belt 105. Other parts and operation of this embodiment are like in the previous one.

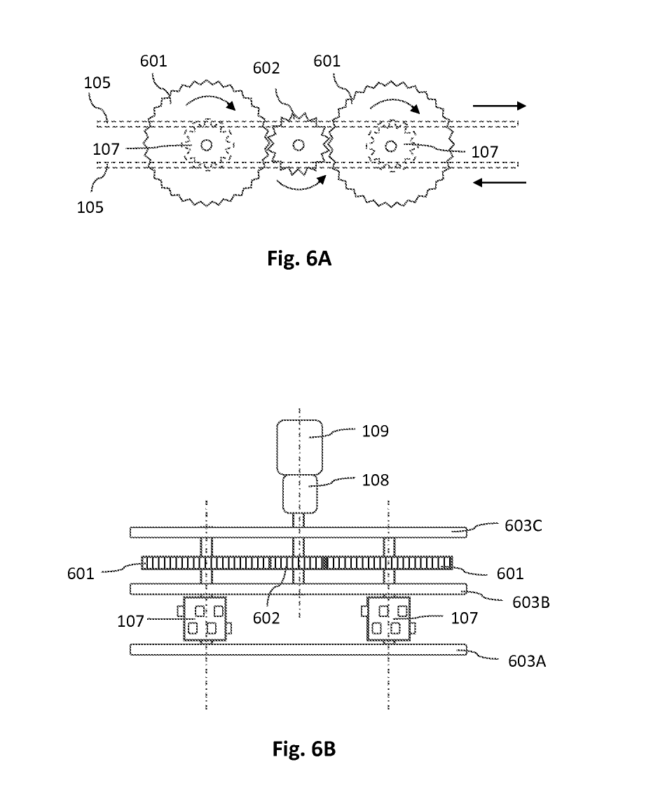

FIG. 6A and FIG. 6B show further refinement of this embodiment. FIG. 6A is a side sectional view. FIG. 6B is a top view with perforated belt omitted. In this refinement, there are two sprockets 107, engaging the same perforated belt 105 (shown by the dashed lines in FIG. 6A). Axles of sprockets 107 are installed on ball bearings in supporting structures 601A and 601B. Each axle of sprocket 107 carries a large gear 601. Both gears 601 mesh with a smaller gear 602. The axle of gear 602 is rotationally connected to the rotor of generator 109, possibly through a gearbox 108. The axle of gear 602 is installed on ball bearings in supporting structures 601B and 601C. One advantage of this refinement is that the torque is split between two sprockets 107. Another advantage is that additional speed increase is performed. This refinement can be applied to the embodiment in FIG. 1 as well.

In this embodiment, even very high power systems may be designed without need in additional speed increase in order to achieve 1,500-1,800 RPM at the nominal conditions, required by most AC generators. Nevertheless, a variable speed gearbox or multiple speeds gearbox is still useful. The speed of perforated belt 105 equals the speed of tether 104 roll out. For maximum power, the optimal speed of the tether roll out is commonly considered to be ⅓ of the scalar value of the wind velocity projection to the tether line (approximately 0.25-0.3 wind speed), although another aspect of this invention challenges this notion as described below. After wind exceeds its nominal value, for which the system is rated, the tether roll out speed should remain constant. Control system 113 shall ensure that by limiting wing speed by changing angle of attack, for example. At all times, the rotor of the generator should rotate with the constant speed, ensuring required frequency of the output AC current. It is desirable for the gearbox to change the ratio, when the wind speed is less or equal the nominal value. If a stepped gearbox is used, after the gear is selected, it becomes the responsibility of control system 113 to maintain constant tether roll out speed by changing angle of attack and other parameters of wings 101.

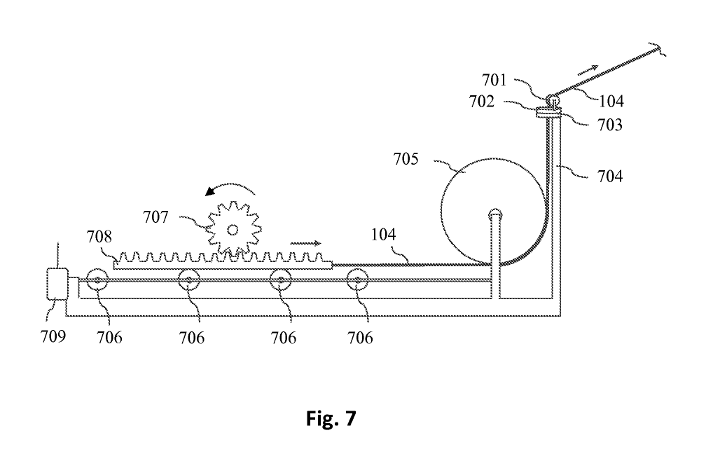

FIG. 7 shows another embodiment, using a rack 708 and a pinion 707 instead of perforated belt 105 and sprocket 107. In this embodiment, tether 104 wraps around a vertical pulley 701, which is installed on rotating platform 702, which is installed on and can rotate relative to a fixed platform 703, which is supported by some structure 704 on the ground. Tether 104 passes vertically through the hole in platforms 702 and 703. Rotation of a platform 702 follows changes in the wind direction, but the position of the tether below a static platform 703 is not affected. Tether 104 wraps around a pulley 705, fixed to the ground, and is attached to rack 708. Rack 708 can move back and forth on rollers 706, installed on the ground as shown in FIG. 7, or attached to rack 708. A control system 709 is provided, similar to control system 113. The airborne subassembly, similar to one in FIG. 1, is used. In the working phase, tether 104 pulls rack 708 to the right, rack 708 engages pinion 707, which transfers rotation to the rotor of electrical generator 109 through gearbox 108. Gearbox 108 and generator 109 are fixed to the ground (not shown in FIG. 7). In the returning phase, energy of the flywheel is used to quickly pull rack 708 to the left, pulling tether 104 back. In other respects, the operation of this embodiment is similar to the operation of other embodiments, described above. This embodiment can be further modified using approaches from other disclosed embodiments, such as providing a second rack, moving in the opposite direction on top. Elements 701-704 with some changes can be used with other embodiments, described above, to minimize size of the rotating platform.

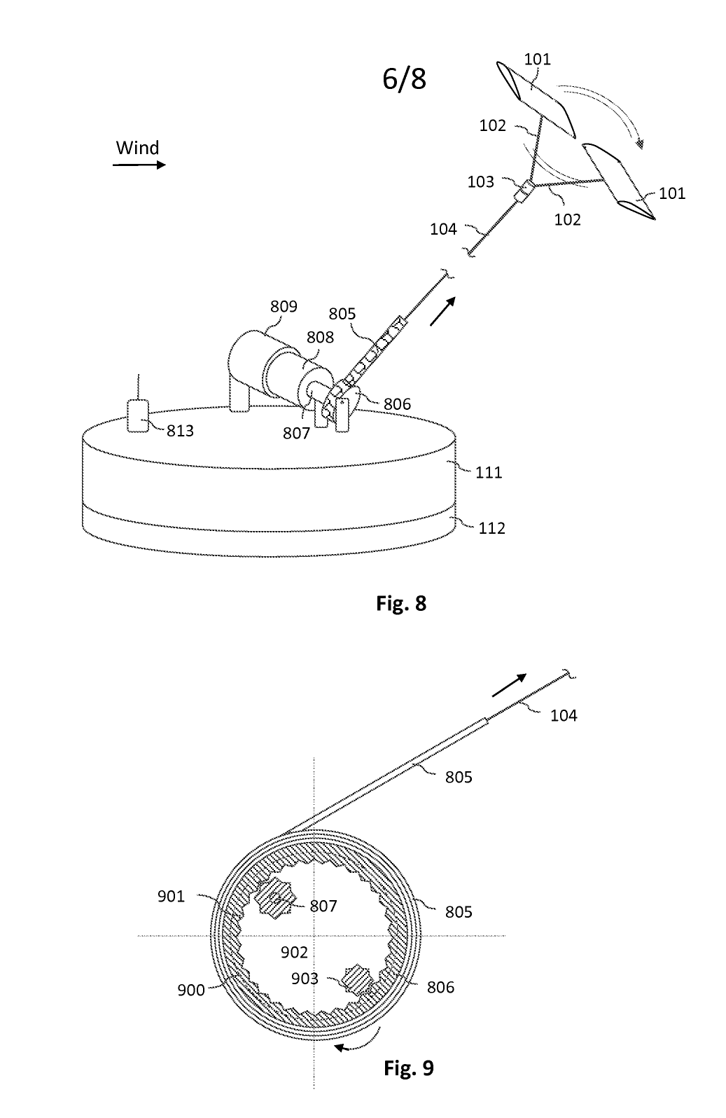

FIG. 8 shows another embodiment of the invention. It comprises the airborne subassembly like the embodiment from FIG. 1. A belt 805 is attached to the bottom end of tether 104. Belt 805 is attached by another end to the surface of a spool 806 and winds on/unwinds from it. Belt 805 winds on spool 806 in multiple layers, each layer exactly on top of the previous one. Spool 806 rests on a pinion or multiple pinions, invisible on FIG. 8. The pinion is set on an axle 807, which extends into an optional gearbox 808. An electrical generator 809 with a rotor and a stator is attached to gearbox 808. Rotation of axle 807 is transferred through gearbox 808 to the rotor of electrical generator 809. Axle 807, gearbox 808 and electrical generator 809 are installed on a platform 111, which can rotate on ball bearings on a foundation 112 and follow changes in the direction of the wind. Platform 111 can be enclosed. The ground based hardware of a control system 813 is placed on platform 111 as well. Control system 813 is similar to control system 113.

FIG. 9 is a sectional view of spool 806. It has a form of an empty cylinder, with an internal gear 900 inside. Internal gear 900 has teeth 901. Internal gear 900 can be manufactured together with spool 806. Teeth 901 are usual gear teeth. Spool 806 does not have an axle in this embodiment. Instead, its internal gear is meshed with a pinion 902, sitting on axle 807, and on one or two idlers 903. These gears keep spool 806 in its place. Pinion 902 resists most of the force, created by belt 805, and increases the speed of rotation of axle 807. Both axle 807 and the axle of idler 903 are held on ball bearings in a structure, installed on platform 111. Operation of the airborne subassembly in this embodiment is similar to the operation of the system in FIG. 1.

Belt 805 can be made of aramids, para-aramids, high or ultra-high molecular weight polyethylene fibers and other sufficiently strong and flexible materials. One advantage of the embodiment is that belt 805 can be very wide and thin, allowing to wrap sufficient length of it around spool 806 of moderate diameter. To keep rotational speed constant despite decrease in the diameter of the outer wrap of belt 805, control system 813 can decrease speed of tether roll out as belt 805 winds from spool 806. Another advantage of this embodiment is that pinion 902 both increases the rotational speed and resists most of the asymmetrical force, exerted by belt 805. Thus, this embodiment allows to decrease costs per kW of nominal power and per kWh of produced energy. Example device parameters:

Peak power: 10 MW
Tether speed: 10 m/s
Tether tension: 1 MN
Tether length: 500-3,000 m
Belt sectional dimensions: 2 mm×300 mm=600 mm²
Belt length: 900 m
Spool diameter: 1 m
Internal ring diameter: 90 cm
Number of belt wraps: 65
Pinion diameter: 30 cm

### Pinion RPM: 640 RPM

Cycle period: 22 seconds

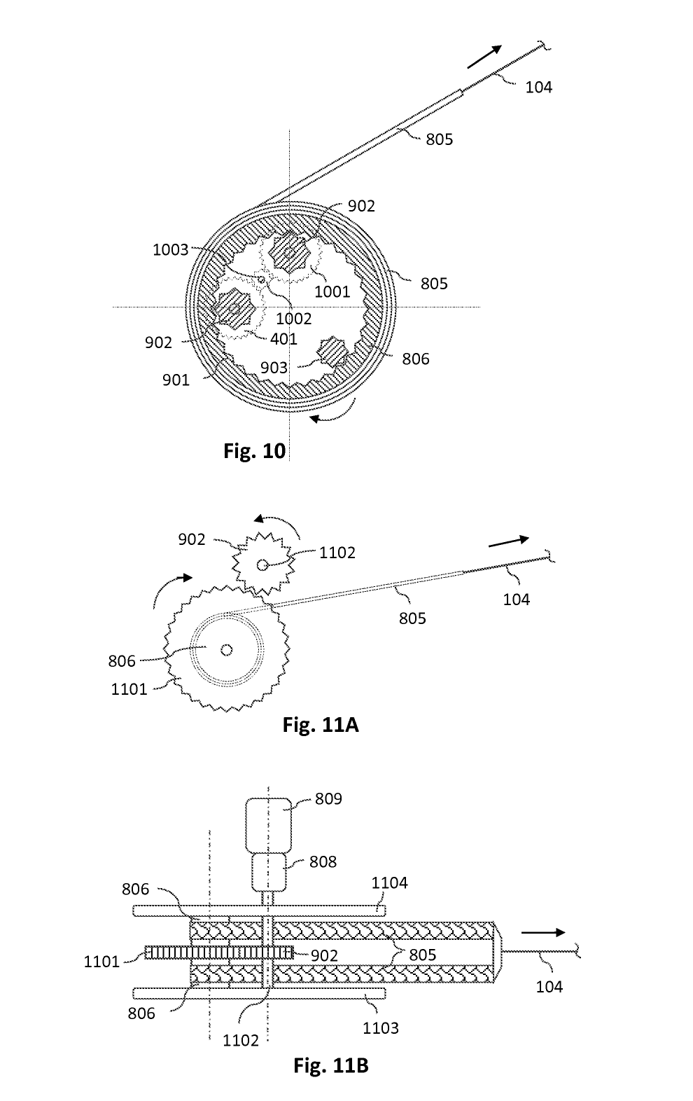

FIG. 10 shows another variation of this embodiment, in which two pinions 902 are meshed with the gear, integrated with spool 806. A gear 1001 of the diameter, larger than the pinion diameter, is installed on each pinion axle. These gears engage a smaller diameter gear 1002. Axle 1003 of gear 1002 transfers the rotation to the rotor of electrical generator 809 through optional gearbox 808. In this variation, each pinion 902 experiences only half of the load, and the rotational speed is increased even further. In another variation, there are four or more pinions, and a planetary gearbox is integrated with spool 806 inside of spool 806. The planetary gearbox transfers rotation at higher frequency to gearbox 808 or directly to generator 809.

FIG. 11A and FIG. 11B show an alternative embodiment, in which an integrated gear 1101 is external to spool 1101. Spool 1101 has a usual axle, installed on ball bearings inside of supporting structures 1103 and 1104, set on platform 111. Most of the load, created by the pull of belt 805, is countered by the teeth of pinion 902, placed externally. For load balancing, integrated gear 1101 is placed in the center of spool 806, and two belts 805 are wrapped around spool 806 on both sides of integrated gear 1101, joined and connected to tether 104 at another end. Axle 1102 of pinion 902 is installed on ball bearings inside of the supporting structured 1103 and 1104. Axle 1001 of gear 1002 transfers the rotation to the rotor of electrical generator 809 through an optional gearbox 808. Two or more pinions 902 can be used, similarly to the previous embodiment. In more embodiments, a planetary gear system can be used, with the gear, integrated with the spool, in the role of the sun, the planet carrier or the annulus. In various embodiments, described above, the gears and pinions are preferably involute. Various gear cuts can be used, including spur gear, helical gear and double helical gear. In another embodiment, the axle of spool 1101 is connected to gearbox 808 directly.

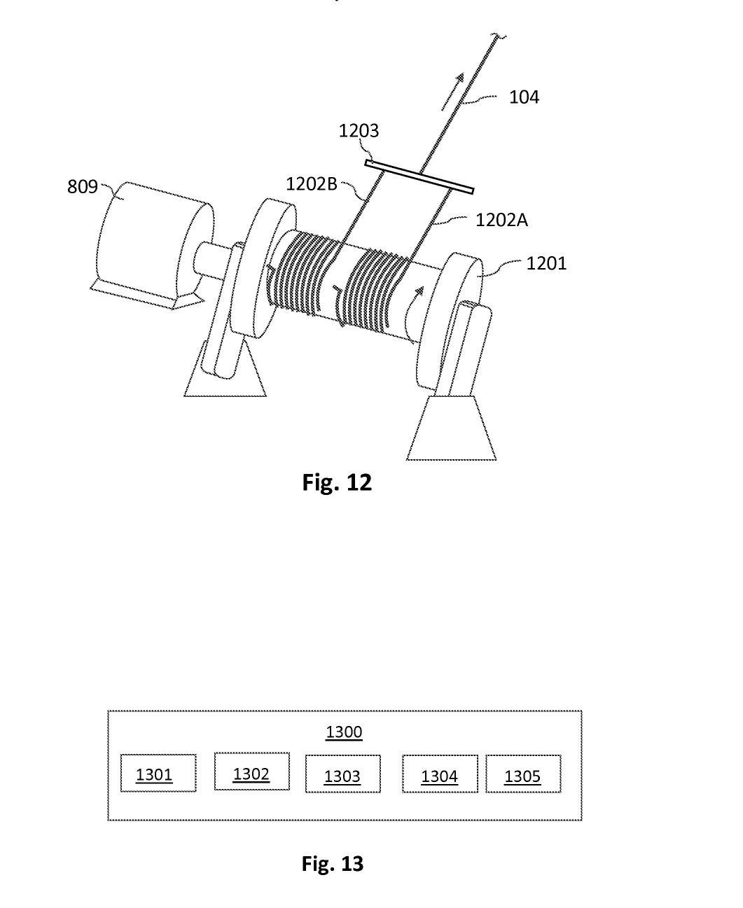

FIG. 12 shows details of another embodiment of the invention. It is similar to AWECS from FIG. 8, where spool 106 is replaced by a spool 1201. Spool 1201 has an axle and is co-axial with the rotor of generator 809, or coupled to it through a gearbox (not shown). Belt 805 is replaced by a plurality of ropes 1202A and 1202B. Ropes 1202A and 1202B are made of a strong fiber, such as ultra-high molecular weight polyethylene, para-aramid or similar. Ropes 1202A and 1202B are attached to one side of a rectangular steel plate 1203. Tether 104 is attached to another side of it. A mechanism is employed to lay ropes 1202A and 1202B on the surface of spool 1203 without crossing itself or one another, when winding the ropes back on spool 1203 in the returning phase. Use of multiple ropes allows to make the ropes thinner than tether 104, maintaining the same total cross section and the same strength. The number of ropes can be significantly larger than two. For example, if 25 ropes are employed, each rope can have 5 times smaller diameter than tether 104. This allows to decrease the diameter of spool 1201 five times compared with an existing mechanisms in which the tether is laid on spool, while maintaining the same wear characteristics. Alternatively, it allows to decrease the diameter of spool 1201 four times, reducing wear of the ropes in the same time. Five times decrease in spool diameter allows proportional increase in the rotational speed for the same speed of cable reel out, and proportional decrease in the torque in the gearbox (for the same power), or even elimination of the gearbox, if the rotational speed is sufficiently high (usually 1,500-1,800 RPM). This allows less expensive construction and scalability to larger power. In a variation of this embodiment, ropes can wind on/off multiple spools 1201. Further, ropes 1202A and 1202B can be attached to plate 1203 by short independent springs to compensate for possibly uneven stretching of the ropes. Flat belts or non-adhesive tapes can be used in place of ropes 1202A and 1202B.

Control system 113 and control system 813 comprise at least one microprocessor, multiple sensors and actuators. It can be distributed, with a part of it being carried by wing 101. Sensors can include day and night cameras; wing GPS, wing speed meter, accelerometer, anemometer and more. Anti-twist device 103 prevents twisting of tether 104 by motion of wings 101. It can be manufactured of two parts, rotating on ball bearings relative to each other. Wing 101 can be of flexible or rigid construction, with appropriate control surfaces and actuators. A kite or a glider can be used as wing 101, with addition of an appropriate control subsystem. Tether 104 and cables 102 can be manufactured from ultra-high molecular weight polyethylene, para-aramids or another strong fiber. Additional benefit is provided if cables 102 are made of self-orienting aerodynamically streamlined cable according to PCT/US12/67143. A single wing, flying cross wind in figure eight path can be used instead of the system of two wings. Additional details on wings, systems of wings, tethers, wing trajectories and control can be found in the publications incorporated here by reference.

The embodiments, described above, can be used together with the flying pulley arrangement from PCT/US12/67143 in order to increase the speed of the elongated member. The embodiments, described above, can be used on land or offshore. Further, with obvious modifications, these embodiments can be used for conversion of energy of moving water: ocean currents, river currents, low head hydro etc.

The following teaching applies to all airborne wind energy conversion systems, not limited to the embodiments described above. It also does not limit the embodiments described above, which can utilize control methods from the existing art. The following terms, as used herein, mean:

AWEC—airborne wind energy conversion
AWECS—airborne wind energy conversion system
Nominal power—maximum output power, for which a wind energy conversion system is designed. Also called a nameplate power or a rated power.
Nominal wind speed—the minimal wind speed, at which the nominal power is achieved by a wind energy conversion system at normal conditions.
Nominal wind—wind having nominal wind speed.
Normal wind speed—the scalar value of the projection of the wind velocity to an axis, perpendicular to the wing motion, and lying in the plane of the wind vector and the wing motion vector. Normal wind speed can be approximately computed by multiplying the wind speed by the cosine of the angle of the tether to the horizontal plane.
Nominal normal wind speed—normal wind speed, corresponding to the nominal wind speed.
Tether reel out speed—tangential speed of the tether, when it is pulled by a wing or a system of the wings, transferring harvested wind energy to the generator. If the tether is winding from a drum on the ground, it is the speed with which the tether winds from the drum.
Relative wind speed (through air)—the normal wind speed in a system coordinates, moving at the tangential velocity component of the tether.
Cross wind flight—motion of the wing with significant velocity component, perpendicular to the direction of the wind. As used herein, this means that the angle between the wing velocity vector and the wind velocity vector is between 45° and 135° (in the ground coordinates), although the most efficient (for AWECS) cross wind flight is at the angle near 90°.

The following Nomenclature is used below:

A—wing area
V_{w}—normal wind speed at the wing altitude
V_{A}—relative wing speed through air
V_{w0}—nominal normal wind speed at the wing altitude
V_{w0 hor}—nominal horizontal wind speed at the wing altitude
C_{L}—lift coefficient of the wing
C_{D}—drag coefficient of the wing with the tether (i.e., including the tether drag)
G—glide ratio; defined as G=C_{L}/C_{D}
R—residual speed coefficient; defined as R=V_{A}/(G*V_{w})
R₀—nominal residual speed coefficient; defined as ratio R at the nominal wind speed
V_{L}—tether reel out speed in the lift power removal mode
r—ratio V_{L}/V_{w} in the lift power removal mode
ρ—air density at the wing altitude

By definition, any AWECS removes some power from its wing (or wings). Residual speed coefficient of an AWECS, as defined in the glossary, is designed to indicate what part of the wing speed remains after removing that power. In the absence of the power removal, residual speed coefficient would be 1.0, i.e., the ratio of the relative wing speed to the wind speed would equal the glide ratio. Loyd derived a formula for the power output, found the maximum and taught (in different terms) that the optimal residual speed coefficient should always be ⅔.

This aspect of the invention teaches that, contrary to Loyd, the nominal residual speed coefficient R₀ should be lower than ⅔, and in some cases significantly. Residual speed coefficient slowly increases, when the wind speed decreases below the nominal, up to ⅔, and then stays at ⅔. When the wind speed increases above the nominal wind speed, relative wing speed through air remains the same, so the residual speed coefficient decreases. This teaching is applicable to all modes of the power removal: lift mode (using tether reel out), drag mode (as described by Loyd, or in the U.S. Pat. No. 8,109,711 by Blumer et al etc.), fast motion transfer (like in PCT/US12/66331) and other.

Some of the advantages that this aspect of the invention provides is a lighter construction of at least the wing and the tether and higher power output when the wind speed is below nominal.

1) Another embodiment of the invention is a device for converting wind energy into another form of energy, comprising: a tethered airfoil, moving cross wind; wherein the strength of the tether and/or the airfoil is optimized for operation with the nominal residual speed coefficient below ⅔.
2) Another embodiment of the invention is a device for converting wind energy into another form of energy, comprising a tethered airfoil, moving cross wind; wherein the strength of the tether and/or the airfoil is optimized for operation with the nominal residual speed coefficient between ⅕ and ½.
3) Another embodiment of the invention is the device from 1) or 2), further comprising an electronic control system for controlling the tethered airfoil.
4) Another embodiment of the invention is the device from 3), further comprising a control element for keeping relative wing speed in the air substantially equal to the minimum of i) ⅔*G*V_{w} and ii) G*R₀*V_{w0}, in the wind speed below the nominal wind speed.
5) Another embodiment of the invention is the device from 3), further comprising: a computing element for setting a low speed threshold below the nominal wind speed and a high speed threshold above the nominal wind speed; and a control element for operating the device to convert wind energy into electrical energy when the wind speed is between the low and the high thresholds and to cease the conversion when the wind speed is below the low threshold or above the high threshold.
6) Another embodiment of the invention is a device from 1)-5), where the another form of energy is the electrical energy.
7) Another embodiment of the invention is a method of converting wind energy into another form of energy, comprising steps of: providing a tethered airfoil; providing an electronic control system; controlling the airfoil to move cross wind; controlling energy removal rate to have residual speed coefficient below ⅔ in the nominal conditions.
8) Another embodiment of the invention is a method of converting wind energy into another form of energy, comprising steps of: providing a tethered airfoil; providing an electronic control system; controlling the airfoil to move cross wind; controlling energy removal rate to have residual speed coefficient between ⅕ and ½ at the nominal wind speed.
9) Another embodiment of the invention is a method from 7)-8), where the another form of energy is the electrical energy.

The special case of AWECS with a ground generator and power removal by tether reel out includes the following summary embodiments:

A1) Another embodiment of the invention is a device for converting wind energy into electrical energy, comprising an airfoil, moving cross wind; a tether, coupled to the airfoil; a rotational member, coupled to the tether; an electrical generator comprising a rotor, wherein the rotor is rotationally coupled to the rotational member; wherein the strength of the tether and/or the airborne member and/or the rotational member is designed for energy conversion when the tether reel out speed is higher than ⅓ of the normal wind speed in the nominal wind.
A2) Further, it is preferred that the strength of the elements of the device from A1) is designed for energy conversion when the tether reel out speed is between ½ and ⅘ of the normal wind speed in the nominal wind.
A3) Another embodiment of the invention is the device from A1), further comprising a control element, ensuring in the winds below the nominal wind that the tether reel out speed substantially equals to the maximum of i) ⅓ of current wind speed and ii) the tether reel out speed, at which the relative wing speed equals the relative wing speed corresponding to the nominal wind speed.
A4) Another embodiment of the invention is the device from A1), further comprising: a computing element for setting a low speed threshold below the nominal wind speed and a high speed threshold above the nominal wind speed; and a control element for operating the device to convert wind energy into electrical energy when the wind speed is between the low and the high thresholds and to cease the conversion when the wind speed is below the low threshold or above the high threshold.
B1) Another embodiment of the invention is a method of converting wind energy into electrical energy, comprising steps of: providing a device for converting wind energy into electrical energy, comprising an airfoil, moving cross wind; a tether, coupled to the airfoil; a rotational member, coupled to the tether; an electrical generator comprising a rotor, wherein the rotor is rotationally coupled to the rotational member; and operating this device to generate electrical energy from wind, while maintaining the tether reel out speed higher than ⅓ of the normal wind speed in the nominal wind.
B2) Another embodiment of the invention is the method from B1), wherein the tether reel out speed is maintained between ½ and ⅘ of the normal wind speed in the nominal wind.
B3) Another embodiment of the invention is the method B1) or B2), further comprising a step of: maintaining the tether reel out speed substantially equal to the maximum of i) ⅓ of current wind speed and ii) the tether reel out speed, at which the relative wing speed equals the relative wing speed corresponding to the nominal wind speed.
B4) Another embodiment of the invention is the method B1) or B2), further comprising a step of: setting a low speed threshold below the nominal wind speed and a high speed threshold above the nominal wind speed; and operating the device to convert wind energy into electrical energy when the wind speed is between the low and the high thresholds and to cease the conversion when the wind speed is below the low threshold or above the high threshold.

In the devices A1-A4 and methods B1-B4, the electrical generator may be placed on or near the ground or the water surface. Examples of the rotational member are a sprocket, a gear, a pinion and a sheave. The tether can be a rope, a wire or a cable. An additional control system can be provided to control the airfoil and the parameters of the system operation. A system comprising multiple airfoils can be used.

It should be noted that the embodiments, described below in more details, work best when the wing has a wide range of angles of attack, having high L/D ratio. Outside of this range, corrections might be required.

The proposed systems and methods can be described in more details on example of the system from FIG. 1. In the working phase, the tether reels out (unrolls) with speed V_{L}, which is a fraction r of the normal wind speed V_{w} (see Nomenclature section). r happens to be equal to 1-R. The higher the reel out speed, the lower is the tension of the tether. V_{w} is approximately the wind speed, multiplied by cosine of the angle between the tether and the horizontal line. As shown by Loyd, with some assumptions, the generated power can be computed as

$$P = \frac{1}{2} {{ρAC}_{L} ( \frac{{C}_{L}}{{C}_{D}} )}^{2} ( 1 - R ) {R}^{2} {V}_{w}^{3} \qquad ( 1 )$$

The maximum power is achieved at R=⅔, therefore the traditional AWECS are designed with this coefficient at the nominal wind. One aspect of this invention is using R₀<⅔, such as R₀=⅓, at the nominal wind. While the rated power of the system decreases, this is more than compensated by other benefits. Let us compare AWECS with R₀=⅓ (i.e., V_{L}=V_{w}*⅔) according to this aspect of the invention (the Super AWECS), with a similar AWECS, utilizing traditional R₀=⅔. We will allow the Super AWECS to have double wing area, compared with the traditional AWECS, to provide the same amount of the power. Comparison of the benefits:
It is easy to see from the equation (1), that both AWECS's produce the same power at the nominal wind
The Super AWECS has V_{A} equal half of that of the traditional AWECS. From the formula for the tension of the tether

$$T = \frac{1}{2} {{ρAC}_{D} ( \frac{{C}_{L}}{{C}_{D}} )}^{2} {R}_{0}^{2} {V}_{w 0}^{2} \qquad ( 2 )$$

one can easily see, that the wing of our Super AWECS experiences only half of the force, acting on the wing of the traditional AWECS. That means that it can be lighter and less expensive, than the wing of the traditional AWECS, despite having twice its area.
The Super AWECS has approximately two times lower tether tension compared with the traditional AWECS (from equation (2)). This allows for thinner and less expensive tether. Even more importantly, this thinner tether has lower drag.
In the Super AWECS, the forces, acting on the mechanisms on the ground, and the torque in the sprocket are approximately two times lower, than in the traditional AWECS. Consequently, many of these mechanisms can be made less expensive.

Thus, the Super AWECS wins hand down against the traditional AWECS.

Another aspect of the invention is the method of operating an AWECS in the winds below nominal wind. Conventional wind turbines and the traditional AWECS (designed with Loyd's R₀=⅔) decrease output proportionally to the decrease in the wind speed in power of 3-that is, very quickly. The AWECS in the embodiment, described above, can operate differently. When the wind speed is below the nominal speed, the system will decrease ratio r in such way, as to keep the value RV_{w} constant and equal to R₀V_{w0}, while keeping R<=⅔. In other words, control system maintains

V_{L}=max(⅓V_{w},V_{w}−R₀V_{w0}) (3)

for V_{w} between V_{min norm} and the nominal wind speed. This allows for much smoother drop in the generated power, than power of three. The system ceases producing energy when V_{w} drops below V_{min norm}. V_{min norm} is the normal wind speed, corresponding to horizontal wind speed Vₘᵢₙ.

When the wind speed is higher than nominal wind speed, but lower than Vₘₐₓ, the system maintains constant power output by utilizing one of the following control strategies:

a) decrease R with increase of the wind speed
b) increase angle of the tether to the horizon
c) decrease angle of attack of the wing, thus decreasing the lift
d) maintain constant tether reel out speed, while decreasing the angle of attack or their combination. Each of these strategies has its own benefits, which should be obvious to one skilled in the art.

The control system has corresponding computational elements, comprising software and hardware, to achieve that, as shown in FIG. 13. A control system 1300, similar to control system 113, additionally a control element 1301, ensuring tether reel out speed according formula (3) in the wind speeds between Vₘᵢₙ and V_{w0 hor}; a control element 1302, ensuring tether reel out speed according to the chosen strategy in the wind speeds between V_{w0 hor} and Vₘₐₓ; a computing element 1303, setting above mentioned values V_{low land}, V_{low takeoff}, Vₘᵢₙ, V_{w0 hor}, Vₘₐₓ, V_{high takeoff}, V_{high land} (all of them are horizontal speeds, in the increasing order); a control element 1304, ensuring landing of the wings when normal wind speed gets below V_{low} land or above V_{high land}; a control element 1305, ensuring raising of the wings when the wings are lowered and the normal wind speed gets above V_{low takeoff} or below V_{high takeoff}; a control element, ensuring ceasing energy production and optimizing wing trajectory for its survival and continuing airborne flight in the horizontal winds between V_{low takeoff} and Vₘᵢₙ and between Vₘₐₓ and V_{high takeoff}. When raising or lowering the wings, weather forecast is taken into account in addition to the current wind. The thresholds are dependent on the parameters of the system and location. Examples of the thresholds:

V_{low land}=2 m/s
V_{low takeoff}=5 m/s

### Vₘᵢₙ=5 m/s

V_{w0 hor}=15 m/s

### Vₘₐₓ=30 m/s

V_{high takeoff}=30 m/s
V_{high land}=35 m/s

Assuming angle of tether to horizon 15°, the horizontal wind speed approximately equals the normal wind speed. More sample parameters:

R₀=⅓

### C_{L}=1.0

### C_{D}=0.1

### G=10.0

### V_{w0}=15 m/s

The following table shows values of V_{L}, V_{A}, and R for sample values V_{w} of in this example.

| V_{w}, m/s | V_{L}, m/s | V_{A}, m/s | R |
|---|---|---|---|
| 5.0 | 1.7 | 33.3 | 0.67 |
| 10.0 | 5.0 | 50.0 | 0.5 |
| 15.0 | 10.0 | 50.0 | 0.33 |

This finishes the detailed discussion of this embodiment with power removal by tether reel out. Similar considerations explain the optimal R and V_{A} in the alternative AWECS types. In alternative AWECS systems, the residual speed coefficient is also controlled by changing power removal rates by the power removal means. For example, in the AWECS with the airborne generators, lower nominal residual speed coefficient can be achieved by increasing the propeller's pitch, or by increasing the strength of the magnetic field in the generator for higher power removal. In the AWECS with fast motion transfer cable (MTC), the lower residual speed coefficient can be achieved by increasing mechanical resistance by the ground generator. Correspondingly, the tension of MTC increases and speed of MTC decreases—as opposite to the behavior of the tether in the tether reel out AWECS. A more general formula can be written, describing relative air speed of AWECS wing in the whole range of allowed normal wind speeds:

V_{A}=min(⅔GV_{w},R₀GV_{w0}) (4)

Thus, an airborne wind energy system with reduced input torque, better torque handling and optimized speed have been disclosed with one or more specific embodiments. While above description contains many specificities, these should not be construed as limitations on the scope, but rather as exemplification of several embodiments thereof. Many other variations are possible and contemplated.

What is claimed is:

1. A device for converting wind energy into electrical energy, comprising:
an airborne member, adapted to harvest wind energy;
a tether, coupled to the airborne member;
an elongated member, coupled to the tether;
a rotational member in contact with the elongated member;
an electrical generator, placed at the ground or water level;
wherein the rotor of the electrical generator is rotationally coupled to the rotational member.

2. The device of claim 1, wherein the airborne member is an airfoil and the device additionally comprises an electronic control system, capable of controlling both the airborne member and the electrical generator.

3. The device of claim 2, wherein the elongated member is non flexible.

4. The device of claim 2, wherein the elongated member is flexible.

5. The device of claim 4, wherein the elongated member is flat.

6. The device of claim 4, wherein the elongated member is a perforated belt.

7. The device of claim 4, wherein the elongated member is a chain.

8. The device of claim 4, wherein the elongated member is relatively straight around its points of contact with the rotational member.

9. The device of claim 4, wherein the rotational member is selected from the group consisting of a sprocket, a gear and a pinion.

10. The device of claim 2, wherein the rotational member and the elongated mesh with each other.

11. The device of claim 5, wherein the elongated member is made of fabric.

12. The device of claim 5, wherein the rotational member is a spool and the elongated member is at least partially wound on the spool.

13. The device of claim 12, further comprising:
a gear, integrally combined with the spool;
a pinion, meshed with the gear; the pinion being rotationally coupled to the rotor.

14. The device of claim 13, wherein the gear is inside of the spool.

15. The device of claim 12, wherein the spool, and the electrical generator are placed on a rotating platform.

16. The device of claim 1, comprising plurality of elongated members.

17. A method of converting wind energy into electrical energy, comprising steps of:
capturing wind energy with a tethered airborne member;
converting motion of the airborne member into periodical linear motion of an elongated member at the ground;
converting the periodical linear motion of the elongated member into rotational motion of the rotational member using frictionless contact;
converting rotational motion of the rotor into electrical energy.

18. A device for converting wind energy into electrical energy, comprising:
an airfoil, adapted to harvest wind energy by moving cross wind;
a tether, coupled to the airfoil and to an object on the ground or in the water;
an electronic control system for controlling the airfoil;
wherein the strength of the tether and of the airfoil is optimized for operation with the nominal residual speed coefficient below ⅔.

19. The device of claim 18, wherein the strength of the tether and of the airfoil is optimized for operation with the nominal residual speed coefficient between ⅕ and ½.

20. The device of claim 18 further comprising:
a computing element for setting a low speed threshold below the nominal wind speed and a high speed threshold above the nominal wind speed;
a control element for operating the device to convert wind energy into electrical energy when the wind speed is between the low and the high thresholds and to cease the conversion when the wind speed is below the low threshold or above the high threshold.
